(19) United States
(12) Patent Application Publication
(10) Pub. No.: US 2024/0183944 A1
(43) Pub. Date: Jun. 6, 2024

(54) INFORMATION PROCESSING DEVICE, INFORMATION PROCESSING METHOD, AND PROGRAM

(71) Applicant: Panasonic Holdings Corporation, Kadoma-shi, Osaka (JP)

(72) Inventors: Takeo UETA, Kanagawa (JP); Hiroshi NOGUCHI, Kanagawa (JP); Toru OKADA, Kanagawa (JP); Makoto YASUGI, Tokyo (JP); Kosuke ONO, Kanagawa (JP)

(21) Appl. No.: 18/576,121

(22) PCT Filed: Dec. 14, 2021
(86) PCT No.: PCT/JP2021/046022

§ 371 Date: Jan. 3, 2024

(30) Foreign Application Priority Data
Jul. 6, 2021 (JP) 2021-112163

(51) Int. Cl. G01S 7/41; G01S 13/92

(52) U.S. Cl. CPC G01S 7/412; G01S 13/92

(57) ABSTRACT

The present invention contributes to the provision of an information processing device and an information processing method with which it is possible to improve accuracy in the assessment of information on a subject to be sensed by a radar device. This information processing device comprises: a combination unit for, on the basis of a time-series change in sensing information produced by a radar device, combining a plurality of items of sensing information that were sensed at a given clock time as sensing information pertaining to a specific sensing subject; a discrimination unit for discriminating an attribute of the sensing subject on the basis of the combined sensing information; and an output unit for outputting the result of discrimination pertaining to the attribute.

### TECHNICAL FIELD

The present disclosure relates to an information processing apparatus, an information processing method, and a program.

### BACKGROUND ART

A vehicle sensing system has been studied in which a radar apparatus senses a vehicle on the road, and measures the velocity of the sensed vehicle or classifies the vehicle type of the sensed vehicle. This vehicle sensing system is used for applications such as speed limit enforcement, a traffic counter, and vehicle type classification at a toll gate of a freeway.

### CITATION LIST

### Patent Literature

Patent Literature 1

Japanese Patent Application Laid-Open No. 2007-163317

### SUMMARY OF INVENTION

### Technical Problem

There is room for consideration in improving the accuracy of determination of information, such as the number of sensing targets, and the sizes, shapes, and kinds thereof, by using a radar apparatus.

One non-limiting and exemplary embodiment facilitates providing an information processing apparatus and an information processing method each capable of improving the accuracy of determination of information on a sensing target by using a radar apparatus.

An information processing apparatus according to an exemplary embodiment of the present disclosure includes: a coupler that performs coupling of, based on a time-series change in sensing information produced by a radar apparatus, a plurality of pieces of the sensing information, which is sensed at a given clock time, as the sensing information on a sensing target which is a specific sensing target; a discriminator that discriminates an attribute of the sensing target based on the sensing information on the sensing target, where the sensing information on the sensing target has been obtained by the coupling; and an outputter that outputs a discrimination result of the attribute.

An information processing method according to an exemplary embodiment of the present disclosure includes: performing, by an information processing apparatus, coupling of, based on a time-series change in sensing information produced by a radar apparatus, a plurality of pieces of the sensing information, which is sensed at a given clock time, as the sensing information on a sensing target which is a specific sensing target; discriminating, by the information processing apparatus, an attribute of the sensing target based on the sensing information on the sensing target, where the sensing information on the sensing target has been obtained by the coupling; and outputting, by the information processing apparatus, a discrimination result of the attribute.

A program according to an exemplary embodiment of the present disclosure causes an information processing apparatus to execute: performing coupling of, based on a time-series change in sensing information produced by a radar apparatus, a plurality of pieces of the sensing information, which is sensed at a given clock time, as the sensing information on a sensing target which is a specific sensing target; discriminating an attribute of the sensing target based on the sensing information on the sensing target, where the sensing information on the sensing target has been obtained by the coupling; and outputting a discrimination result of the attribute.

It should be noted that general or specific embodiments may be implemented as a system, an apparatus, a method, an integrated circuit, a computer program, a storage medium, or any selective combination thereof.

According to an exemplary embodiment of the present disclosure, it is possible to improve the accuracy of determination of information on a sensing target by using a radar apparatus.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a first example of vehicle sensing using a radar apparatus;

FIG. 2 illustrates a second example of the vehicle sensing using the radar apparatus;

FIG. 3 illustrates an example of a configuration of a vehicle sensing system according to an embodiment;

FIG. 4 is a flowchart illustrating an example of signal processing in the embodiment;

FIG. 5 illustrates exemplary results obtained by the signal processing in the embodiment;

FIG. 6 illustrates a third example of the vehicle sensing using the radar apparatus;

FIG. 7A illustrates an example of the positional relationship between the radar apparatus and a sensing target;

FIG. 7B illustrates an example of the positional relationship between the radar apparatus and a sensing target;

FIG. 7C illustrates an example of the positional relationship between the radar apparatus and a sensing target;

FIG. 8 illustrates exemplary clusters;

FIG. 9 is a flowchart illustrating an example of first determination in cluster coupling processing;

FIG. 10 illustrates an example of processing procedures based on FIG. 9;

FIG. 11 illustrates a first example of the coupling processing based on a cluster coupling table;

FIG. 12 illustrates a second example of the coupling processing based on a cluster coupling table;

FIG. 13 illustrates a determination example in a case where the cluster coupling processing is not performed;

FIG. 14 illustrates a determination example in a case where the cluster coupling processing is performed;

FIG. 15 illustrates a first example of vehicle type classification based on type information and likelihood information of a plurality of frames;

FIG. 16 illustrates the first example of the vehicle type classification based on type information and likelihood information of a plurality of frames;

FIG. 17 illustrates the first example of the vehicle type classification based on type information and likelihood information of a plurality of frames;

FIG. 18 illustrates exemplary time-spatial features (TSF); and

FIG. 19 is a flowchart illustrating an example of time-series information processing.

### DESCRIPTION OF EMBODIMENTS

Hereinafter, a preferred embodiment of the present disclosure will be described in detail with reference to the accompanying drawings. Note that, in the present specification and drawings, components having substantially the same functions are provided with the same reference signs to omit redundant description.

### One Embodiment

### Knowledge Leading to the Present Disclosure

For example, a vehicle sensing system has been studied in which a radar apparatus attached to a structure such as a utility pole and a pedestrian overpass senses a vehicle on the road, and measures the velocity of the sensed vehicle or classifies the vehicle type of the sensed vehicle. This vehicle sensing system may be used for applications such as speed limit enforcement, a traffic counter, and vehicle type classification at a toll gate of a freeway.

For example, the radar apparatus in the vehicle sensing system transmits a radio wave (transmission wave) and receives a reflection wave that is a transmission wave reflected by a sensing target (for example, a vehicle). The radar apparatus or a control apparatus that controls the radar apparatus generates, for example, based on the received reflection wave, information on a set of reflection points (hereinafter referred to as a point cloud) corresponding to the sensing target (hereinafter, the information will be referred to as point cloud information), and outputs the generated point cloud information to an information processing apparatus. The point cloud indicates, for example, the locations at which the reflection points corresponding to the sensing target are present, and the shape and size of the sensing target in a sensing region in which the position of the radar apparatus is used as the origin.

In the point cloud information, the number of point clouds corresponding to one sensing target is not limited to one. In a case where a large motor vehicle such as a truck and a bus is a sensing target, two or more point clouds may appear for the one large motor vehicle.

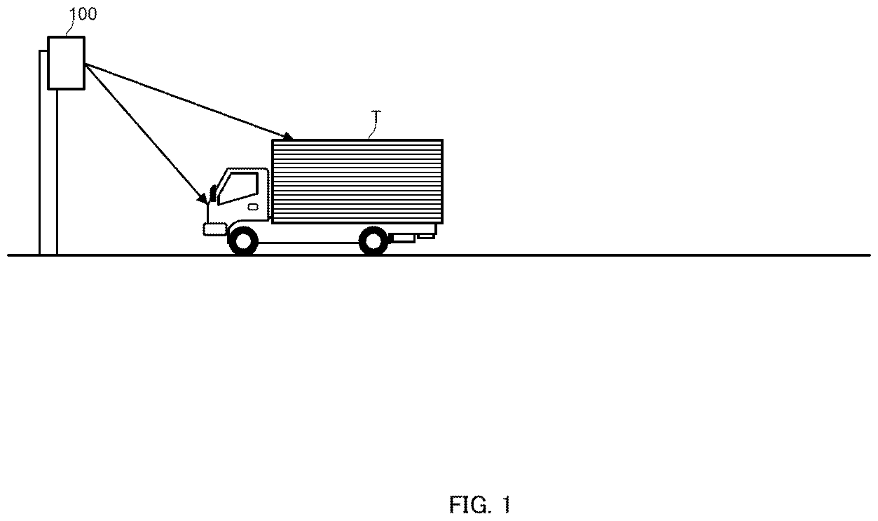

FIG. 1 illustrates a first example of vehicle sensing using radar apparatus 100. FIG. 1 illustrates radar apparatus 100 and truck T as a sensing target for radar apparatus 100. In the example in FIG. 1, the transmission waves transmitted from radar apparatus 100 are reflected at two points in a portion in front of the driver's seat of the truck and a portion above the load bed of the truck, and radar apparatus 100 receives reflection waves reflected at the two points. Since the distance between the two reflection points exemplified in FIG. 1 is relatively large, two point clouds appear from the one track in point cloud information.

In a case where two or more point clouds are obtained for a large motor vehicle, the

point clouds may be separated from each other in distance in a sensing region. In such a case, it may be difficult to determine that the two or more point clouds correspond to one sensing target (for example, a large motor vehicle). For example, in such a case, it may be erroneously determined that each of the two or more point clouds corresponds to a sensing target (for example, a standard motor vehicle or a small motor vehicle) smaller than the large motor vehicle.

Further, in a case where a sensing target is a moving body (for example, a vehicle), a reflection point in the sensing target changes as the position of the sensing target viewed from radar apparatus 100 changes according to the passage of time. For example, even in a case where a radio wave is reflected at a reflection point in an upper portion of a vehicle at a given time point, a radio wave may be reflected at a reflection point in a lower portion of the vehicle at another time point. As described above, in a case where a reflection point changes according to the passage of time, variations may occur in feature values obtained from point clouds.

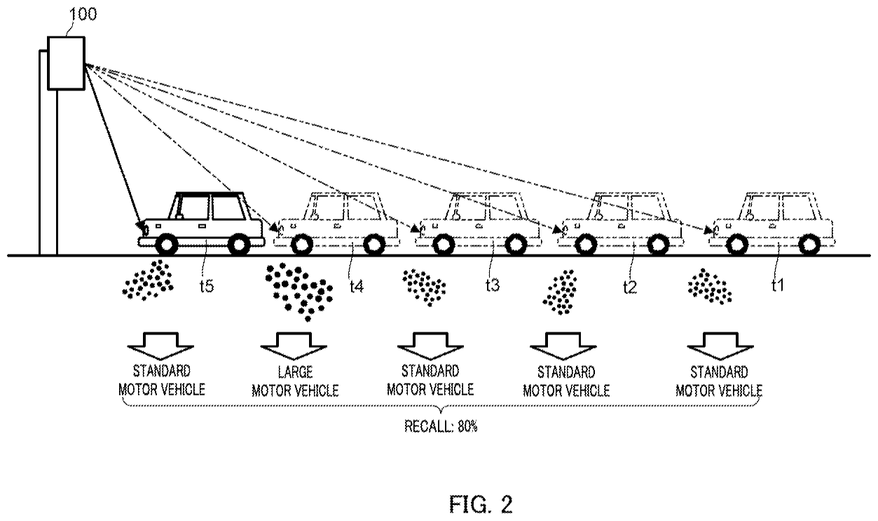

FIG. 2 illustrates a second example of the vehicle sensing using radar apparatus 100. FIG. 2 illustrates radar apparatus 100, a vehicle traveling in a direction in which the vehicle is approaching radar apparatus 100, point clouds generated based on reflection waves reflected by the vehicle, and vehicle type classification results in which vehicle types are classified based on feature values obtained from the point clouds. Note that, as an example, FIG. 2 illustrates the positions of the vehicle, the point clouds, and the vehicle type classification results at five time points of time point t1 through time point t5, respectively. Here, in the example of FIG. 2, the feature value obtained at t4 differs from the feature values obtained at the other time points. For example, the reflection point in the vehicle at t4 may differ from the reflection points in the vehicle at t1 to t3 and t5 as the positional relationship between the radar apparatus and the vehicle changes. In this case, the feature value at t4 may differ from the feature values at t1 to t3 and t5.

In the example of FIG. 2, the classification results at t1 to t3 and t5 are “standard motor vehicle”, whereas the classification result at t4 is “large motor vehicle”. The sensing target in the case in FIG. 2 is a “standard motor vehicle”, and thus, the proportion of correct determinations (recall) in which the sensing target is correctly determined as “standard motor vehicle” is 80%. In a case where variations are present in feature values obtained from point clouds as exemplified in FIG. 2, an error may occur in vehicle type classification (determination) based on the point clouds.

The present disclosure indicates, for example, exemplary configurations and operations each capable of improving the accuracy of sensing (or determination) in a vehicle sensing system using a radar apparatus. Note that, “sensing” may be read as “detection”. “Determination” may be read as “discrimination”, “identification” or “recognition”. Further, the vehicle type classification may be read as vehicle type discrimination in the following description.

### Examples of System Configuration and Processing Procedures

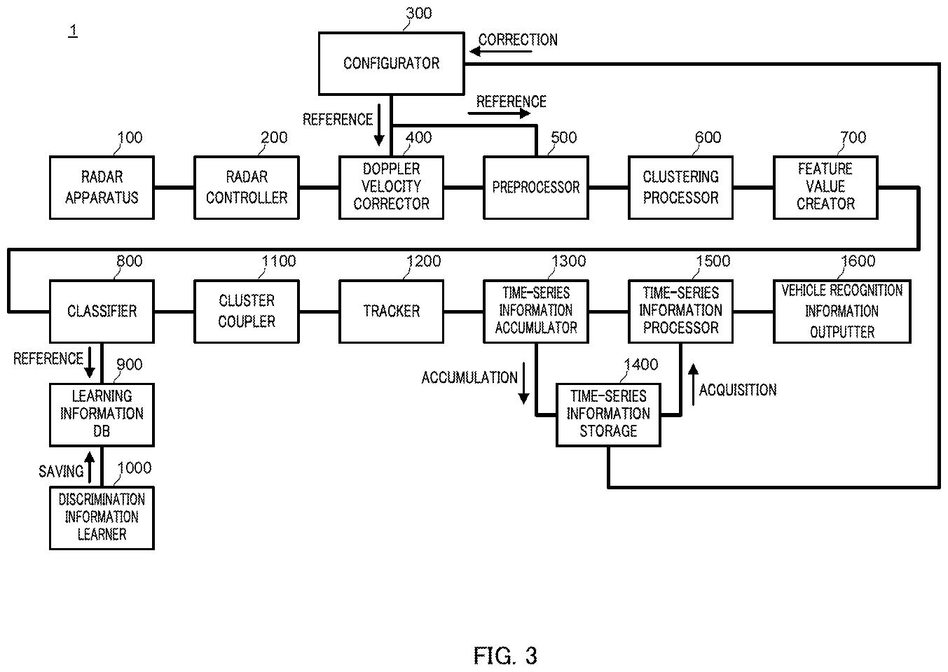

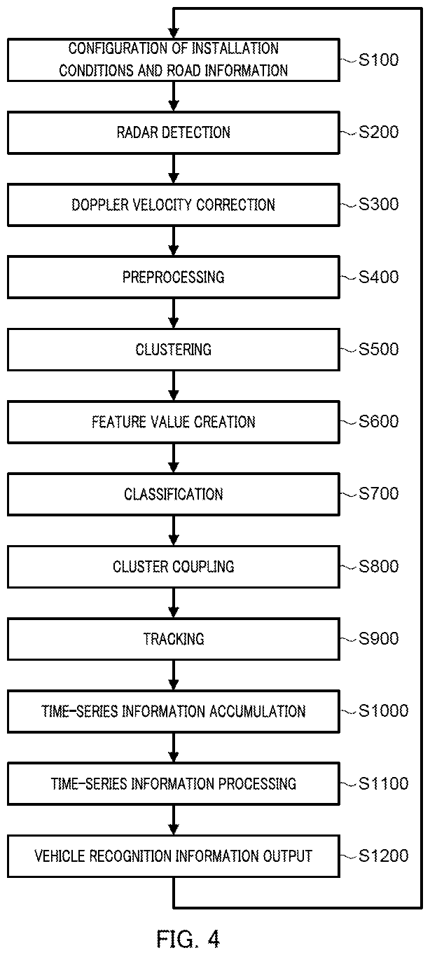

FIG. 3 illustrates an example of a configuration of vehicle sensing system 1 according to the present embodiment. FIG. 4 is a flowchart illustrating an example of signal processing in the present embodiment. Hereinafter, vehicle sensing system 1 and an example of signal processing in vehicle sensing system 1 according to the present embodiment will be indicated with reference to FIGS. 3 and 4.

Vehicle sensing system 1 according to the present embodiment includes, for example, radar apparatus 100, radar controller 200, configurator 300, Doppler velocity corrector 400, preprocessor 500, clustering processor 600, feature value creator 700, classifier 800, learning information database (DB) 900, discrimination information learner 1000, cluster coupler 1100, tracker 1200, time-series information accumulator 1300, time-series information storage 1400, time-series information processor 1500, and vehicle recognition information outputter 1600.

Note that, each configuration indicated in FIG. 3 may have the form of a signal processing apparatus (or information processing apparatus), or two or more of the configurations indicated in FIG. 3 may be included in one signal processing apparatus (or information processing apparatus). For example, among the configurations illustrated in FIG. 3, the configurations except for radar apparatus 100 may be included in one signal processing apparatus (or information processing apparatus), and this signal processing apparatus may be connected to radar apparatus 100 by radio or wire. Further, the configurations illustrated in FIG. 3 may be dispersedly disposed in a plurality of signal processing apparatuses (or information processing apparatuses). For example, all the configurations, including radar apparatus 100, illustrated in FIG. 3 may be included in one signal processing apparatus (or information processing apparatus).

Further, pieces of processing corresponding to configurator 300, Doppler velocity corrector 400, preprocessor 500, clustering processor 600, feature value creator 700, classifier 800, learning information DB 900, discrimination information learner 1000, cluster coupler 1100, tracker 1200, time-series information accumulator 1300, time-series information storage 1400, and time-series information processor 1500 may be executed by one piece of software. In this case, a piece of software that executes processing corresponding to radar controller 200 and a piece of software that executes processing corresponding to vehicle recognition information outputter 1600 may be pieces of software different from each other.

Radar apparatus 100, for example, transmits a transmission wave and receives a reflection wave that is a transmission wave reflected by a sensing target.

Configurator 300 configures installation conditions and road information (S100 in FIG. 4). The installation conditions may be, for example, conditions with respect to the position in which radar apparatus 100 is installed. Further, the road information may include, for example, information on a road present in a sensing range of radar apparatus 100. For example, the road information may include information on at least one of the width of the road, the direction in which the road extends, and the traveling direction of a vehicle traveling on the road. Further, the installation conditions and the road information may be corrected based on time-series information. For example, configurator 300 may estimate the orientation of radar apparatus 100 based on a locus of movement of a vehicle indicated by the time-series information and correct a difference between the above orientation and an orientation indicated by the installation conditions. The correction here makes it possible to eliminate or reduce a deviation between information on area designing of an area in which radar apparatus 100 is to be installed and information on the actual installation of radar apparatus 100.

Radar controller 200 controls, for example, radar apparatus 100 such that radar apparatus 100 performs detection of a sensing target (hereinafter which may also be referred to as “radar detection”) (S200 in FIG. 4). Radar controller 200 may perform control, for example, based on a difference in performance of radar apparatus 100. For example, the performance of radar apparatus 100 may be indicated by at least one of a sensing range, a sensing period, and a sensing accuracy of radar apparatus 100. Radar controller 200, for example, acquires a reflection wave from radar apparatus 100 and generates point cloud information based on information such as the reception timing of the reflection wave and the reception intensity of the reflection wave. The point cloud information may include, for example, the position of a point cloud and the Doppler velocity of a sensing target corresponding to the point cloud.

Doppler velocity corrector 400 corrects, for example, a sensed Doppler velocity by referring to the installation conditions and road information for radar apparatus 100 (S300 in FIG. 4). Note that, Doppler velocity correction processing in S300 will be described later.

Preprocessor 500 performs, for example, preprocessing of the point cloud information by referring to the installation conditions and road information for radar apparatus 100 (S400 in FIG. 4). The preprocessing may include, for example, processing of generating, based on the point cloud information acquired from radar apparatus 100, point cloud information to be outputted to clustering processor 600. Further, the preprocessing may include, for example, processing such as noise removal, filtering, and coordinate transformation. For example, the point cloud information acquired from radar apparatus 100 may include point cloud information in a polar coordinate system defined by a distance starting from radar apparatus 100 and angles (an elevation angle and an azimuth angle) viewed from radar apparatus 100. Further, the preprocessing may also include processing of increasing point cloud information by using information on several frames at past time points before a current time point, and processing of making height information constant in the point cloud information to be outputted to clustering processor 600 such that a cluster does not split in the height direction in a case where clustering is performed. Preprocessor 500 may convert this point cloud information into point cloud information in an orthogonal coordinate system using the position of radar apparatus 100 as a reference.

Note that, the orthogonal coordinate system may be represented by the X, Y, Z coordinates. For example, it may be configured such that the surface on which a vehicle travels is the X-Y plane with Z=0, and the point immediately below the position of radar apparatus 100 on the X-Y plane with Z=0 is the origin (that is, the point with X=Y=Z=0). Further, the Y-axis may be an axis along a direction perpendicular to a radar board. For example, a point with a smaller Y-coordinate indicates that the point is closer to radar apparatus 100.

Clustering processor 600 performs, for example, clustering processing on the point cloud information (S500 in FIG. 4). For example, density-based spatial clustering of applications with noise (DBSCAN) may be used in the clustering processing. In the clustering processing, a point cloud is subjected to clustering to generate a cluster based on the point cloud information obtained by the preprocessing described above. Note that, the algorithm used in the clustering processing is not limited to the DBSCAN. Further, clustering processor 600 gives identification information (for example, an ID) for identifying each generated cluster to each cluster.

Feature value creator 700 creates a feature value (S600 in FIG. 4). For example, a feature value may be created for each cluster. The feature value may include at least one of eleven parameters indicated below:
the radius of the minimum circle including a point cloud(s) in a cluster;
the number of point clouds in a cluster;
   the proportion of core points in a cluster;
   cluster covariance indicating variations of the positions of point clouds in a cluster;
   the width of a point cloud in a cluster in the X coordinate;
   the width of a point cloud in a cluster in the Y coordinate;
the width of a point cloud in a cluster in the Z coordinate;
the average Doppler velocity of point clouds in a cluster;
Doppler velocity variance of point clouds in a cluster;
the average signal to noise ratio (SNR) of point clouds in a cluster; and
SNR variance of point clouds in a cluster.

Here, the proportion of core points in a cluster may be, for example, a feature value in a case where DBSCAN or Grid-Based DBSCAN is used at clustering processor 600. Further, the width in the X coordinate may be, for example, the difference between the maximum and minimum values of a point cloud in the X coordinate. The width in the Y coordinate and the width in the Z coordinate may also be the same as the width in the X coordinate.

Classifier 800 classifies, for example, the type (vehicle type) of a target (for example, a vehicle) sensed by radar apparatus 100 based on a feature value created by feature value creator 700 (S700 in FIG. 4). For example, classifier 800 classifies vehicle types in a cluster based on feature values created for each cluster, a machine learning model termed as support vector machine (SVM), and learning information stored in advance. Note that, the “type” of a sensing target, such as the “vehicle type”, may be read as the “attribute” of the sensing target. Classifier 800 outputs information in which a cluster is associated with a vehicle type determined for the cluster.

Learning information database (DB) 900 stores, for example, learning information to be referred to in the classification by classifier 800.

Discrimination information learner 1000 performs, for example, learning processing of generating the learning information used for vehicle type classification.

Cluster coupler 1100 performs, for example, cluster coupling processing (S800 in FIG. 4). Note that, the cluster coupling processing in S800 will be described later.

Tracker 1200 pursues (tracks), for example, a cluster in time series (S900 in FIG. 4). Here, the cluster to be pursued in time series by tracker 1200 may be a cluster on which coupling processing is performed by cluster coupler 1100, or may be a cluster on which no coupling processing is performed. Further, even in each configuration in stages subsequent to tracker 1200, a cluster to be processed may be a cluster on which coupling processing is performed by cluster coupler 1100, or may be a cluster on which no coupling processing is performed.

For example, tracker 1200 performs tracking in time series by using a Kalman filter and joint probabilistic data association (JPDA). Tracker 1200 performs tracking to thereby determine clusters corresponding to the same sensing target at time points different from each other. Tracker 1200 gives the same identification information (ID) to clusters corresponding to the same sensing target at time points different from each other.

Time-series information accumulator 1300 accumulates, for example, time-series information in time-series information storage 1400 (S1000 in FIG. 4). The time-series information includes, for example, information on a cluster at a current time point and a cluster at a past time point before the current time point. In the information on the cluster at the current time point and the cluster at the past time point before the current time point, the same identification information is given to the clusters corresponding to the same sensing target at the time points different from each other. Further, in the time-series information, each cluster at each time point is associated with a classification result of each vehicle type corresponding to each cluster.

Time-series information processor 1500 performs, for example, time-series information processing based on the time-series information accumulated in time-series information storage 1400 (S1100 in FIG. 4). Note that, the time-series information processing in S1100 will be described later.

Vehicle recognition information outputter 1600 outputs, for example, vehicle recognition information obtained by the time-series information processing (S1200 in FIG. 4). The vehicle recognition information may include at least some of information such as a vehicle type, the velocity of a vehicle, identification information given to the vehicle, and position information of the vehicle.

Vehicle sensing system 1 may execute the processing illustrated in FIG. 4 periodically or non-periodically (for example, in response to an instruction from an external apparatus), for example. For example, the processing illustrated in FIG. 4 may be executed in a period corresponding to the sensing period of radar apparatus 100.

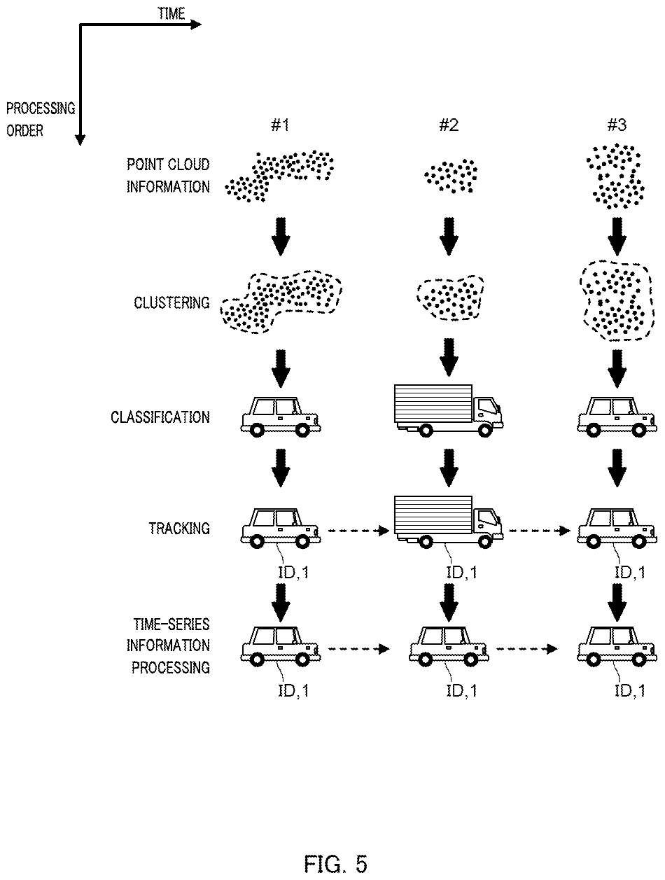

FIG. 5 illustrates exemplary results obtained by the signal processing in the present embodiment. FIG. 5 illustrates examples of point cloud information generated at three time points of #1 to #3 and processing results with respect to the point cloud information.

For example, clustering processor 600 in FIG. 3 generates a cluster by subjecting point cloud information to clustering as illustrated in FIG. 5.

Then, a feature value is created for the cluster and vehicle type classification for the cluster is executed by classifier 800 in FIG. 3 as illustrated in FIG. 5. In the example of FIG. 5, the clusters at time points #1 and #3 are classified as the vehicle type of “standard motor vehicle”, and the cluster at time point #2 is classified as the vehicle type of “large motor vehicle”.

Next, after the coupling processing in the clustering is executed, tracker 1200 performs cluster tracking in time series. In the case of the example of FIG. 5, the clusters at time points #1 to #3 are determined as clusters corresponding to the same sensing target by performing tracking. In this case, the same ID may be given to the clusters corresponding to the same sensing target as illustrated in FIG. 5.

Time-series information processor 1500 performs the time-series information processing on the tracking results. In the case of FIG. 5, the classification result of the vehicle type at time point #2 is changed from the “large motor vehicle” to the “standard motor vehicle” (in other words, the classification is modified) as a result of the time-series information processing.

Next, examples of Doppler velocity correction by Doppler velocity corrector 400, cluster coupling processing by cluster coupler 1100, and time-series information processing by time-series information processor 1500 will be described.

### Doppler Velocity Correction Processing

An example of Doppler velocity correction processing by Doppler velocity corrector 400 will be described.

Information outputted by radar apparatus 100 includes a Doppler velocity. The Doppler velocity corresponds, for example, to the moving velocity of a sensing target. The Doppler velocity is determined, for example, based on a change in the distance between the sensing target and radar apparatus 100.

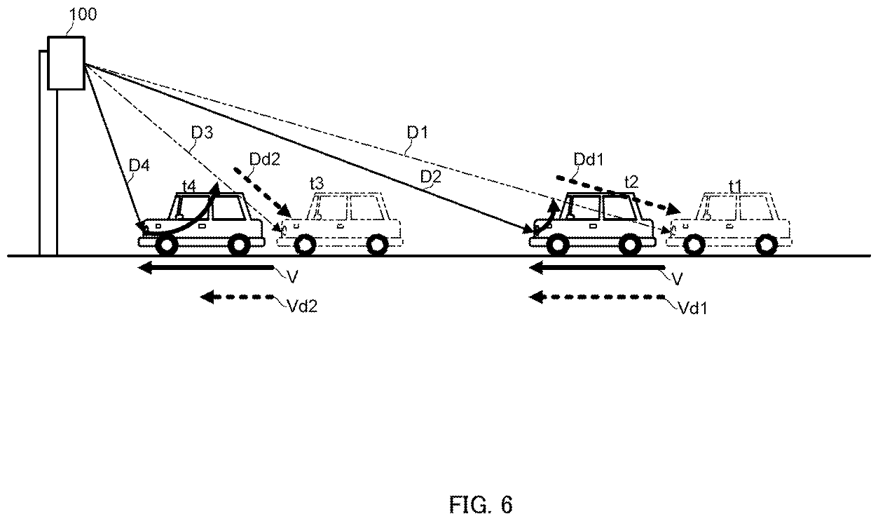

FIG. 6 illustrates a third example of the vehicle sensing using radar apparatus 100. FIG. 6 illustrates radar apparatus 100 and a vehicle traveling at velocity V, which is constant, in a direction in which the vehicle is approaching radar apparatus 100. Further, as an example, FIG. 6 illustrates Doppler velocity Vd1 based on the movement of the vehicle from time point t1 to time point t2 and Doppler velocity Vd2 based on the movement of the vehicle from time point t3 to time point t4. Note that, the time interval between time point t1 and time point t2 may be the same as the time interval between time point t3 and time point t4.

Doppler velocity Vd1 is determined based on change amount Dd1 between distance D1 between the vehicle and radar apparatus 100 at time point t1 and distance D2 between the vehicle and radar apparatus 100 at time point t2. Doppler velocity Vd2 is determined based on change amount Dd2 between distance D3 between the vehicle and radar apparatus 100 at time point t3 and distance D4 between the vehicle and radar apparatus 100 at time point t4.

In the case of FIG. 6, Doppler velocity Vd2 is smaller than Doppler velocity Vd1 because change amount Dd2 is smaller than change amount Dd1.

As exemplified in FIG. 6, a difference between the Doppler velocity and the velocity of the vehicle, both of which can be sensed by radar apparatus 100, occurs depending on the positional relationship between radar apparatus 100 and the vehicle. For example, even in a case where the vehicle is traveling at a constant velocity, the closer the vehicle is to radar apparatus 100, the smaller the change amount in the distance between the vehicle and radar apparatus 100, and thus, a Doppler velocity smaller than the velocity of the vehicle is sensed.

Doppler velocity corrector 400 corrects, for example, a Doppler velocity based on the positional relationship between radar apparatus 100 and a vehicle. Doppler velocity correction makes it possible to estimate the velocity of the vehicle more accurately.

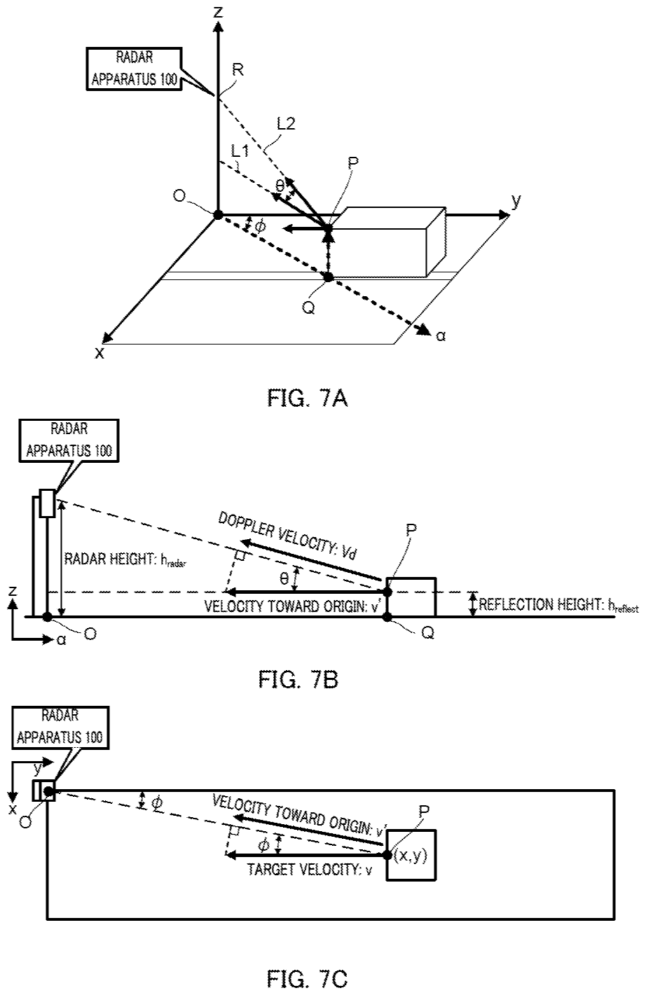

FIGS. 7A, 7B, and 7C illustrate examples of the positional relationship between radar apparatus 100 and a sensing target. FIGS. 7A, 7B, and 7C illustrate examples of the positional relationship between radar apparatus 100 and a sensing target in the X-Y-Z space. Note that, in these examples, the sensing target travels straight on a plane. Hereinafter, examples of Doppler velocity correction in a case where a reflection wave that is a radio wave (transmission wave) reflected at reflection point P of the sensing target is received by radar apparatus 100 are indicated.

In FIGS. 7A, 7B, and 7C, the X-axis and Y-axis are defined as being parallel to the plane (road surface) on which the sensing target moves. In other words, the X-Y plane is parallel to the plane on which the sensing target moves. The Z-axis is defined as a direction perpendicular to the plane on which the sensing target moves. As an example, the X-Y plane with Z=0 is defined as the plane on which the sensing target moves. Further, the Y-axis is defined along the direction in which the sensing target moves. In these examples, the sensing target travels straight in the negative direction of the Y-axis.

Further, in FIGS. 7A, 7B, and 7C, X=0 and Y=0 are defined for the position at which radar apparatus 100 is provided. For example, as illustrated in FIG. 7B, in a case where the height from the plane (the X-Y plane with Z=0), on which the sensing target moves, to the position, at which radar apparatus 100 is provided, is expressed as hradar, the X, Y, Z coordinates indicating the position at which radar apparatus 100 is provided are (X, Y, Z)=(0, 0, h_{radar}).

Point Q in FIG. 7A indicates an intersection point of a straight line, which passes through reflection point P and is parallel to the Z-axis, and the X-Y plane with Z=0. The α-axis indicated in FIG. 7A is the axis of a straight line extending from origin O of the X-Y-Z space in a direction of point Q. The angle formed by the Y-axis and the α-axis is expressed as φ.

FIG. 7B illustrates a plane (α-Z plane) along the a-axis and the Z-axis in FIG. 7A. FIG. 7C illustrates the X-Y plane with Z=0 in FIG. 7A.

Line segment L1 illustrated in FIGS. 7A and 7B is parallel to the a-axis and extends from the Z-axis to reflection point P. Line segment L2 is a line segment between reflection point P and point R at which radar apparatus 100 is provided. The angle formed by straight lines L1 and L2 is expressed as θ. Further, the X, Y, Z coordinates indicating the position of reflection point P are (X, Y, Z)=(Px, Py, h_{reflect}). The position of reflection point P (for example, the X, Y, Z coordinates) is calculated based on a reflection wave received by radar apparatus 100.

Target velocity V indicates the moving velocity of the sensing target. Velocity V′ indicates the velocity component along the a-axis in target velocity V. Doppler velocity Vd is calculated based on a reflection wave reflected at reflection point P.

As illustrated in FIG. 7B, the relationship of Vd=V′ cosθ holds between velocity V′ and Doppler velocity Vd. Further, as illustrated in FIG. 7C, the relationship V′=V_{cosφ} holds between target velocity V and velocity V′. For this reason, target velocity V is expressed as equation 1 by using θ, φ, and Doppler velocity Vd.

$$\begin{matrix}[ 1 ] & \\ V = \frac{Vd}{cos θ cos ϕ} & ( Equation 1 )\end{matrix}$$

Here, as illustrated in FIG. 7B, θ is expressed as equation 2 based on the position of reflection point P and the position (height) of radar apparatus 100.

$$\begin{matrix}[ 2 ] & \\ θ = {tan}^{- 1} ( \frac{{h}_{radar} - {h}_{reflect}}{\sqrt{{P}_{x}^{2} + {P}_{y}^{2}}} ) & ( Equation 2 )\end{matrix}$$

Further, as illustrated in FIG. 7C, φ can be expressed as equation 3 based on the position of reflection point P.

$$\begin{matrix}[ 3 ] & \\ ϕ = {tan}^{- 1} ( \frac{{P}_{x}}{{P}_{y}} ) & ( Equation 3 )\end{matrix}$$

Doppler velocity Vd is corrected based on θ calculated by equation 2, φ calculated by equation 3, and equation 1. Target velocity V is estimated by this correction.

### Cluster Coupling Processing

Next, the cluster coupling processing will be described. In the cluster coupling processing, by focusing on, for example, the fact that even when a cluster corresponding to one sensing target (for example, a vehicle) is separated into a plurality of clusters, loci of temporal changes in the plurality of separated clusters overlap, past cluster information is used and it is determined whether cluster coupling is possible.

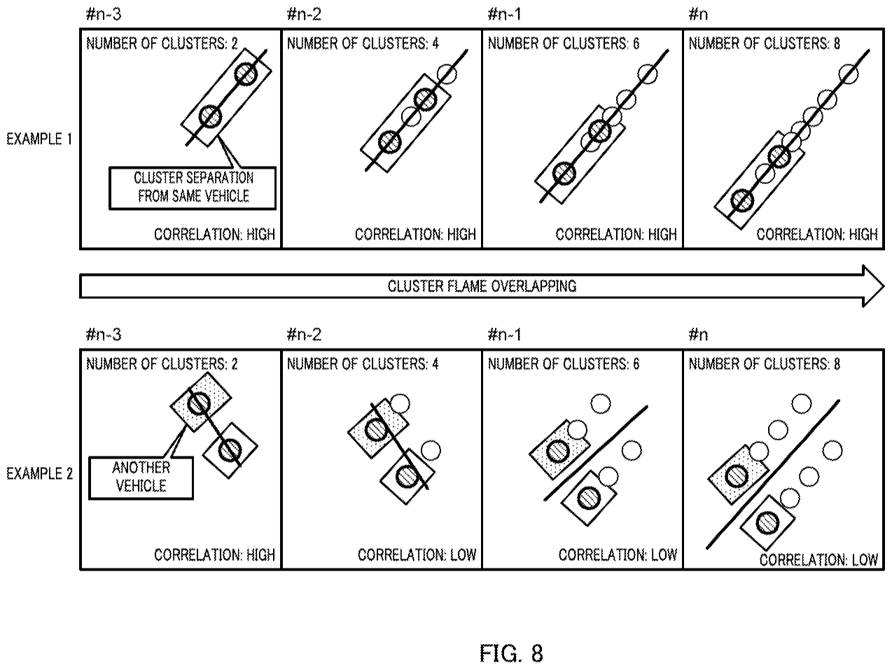

FIG. 8 illustrates exemplary clusters. FIG. 8 exemplifies positions of the clusters in a case where a vehicle(s) as a sensing target(s) is/are viewed from above. FIG. 8 illustrates Example 1, in which two clusters are separated from one vehicle and are sensed, and Example 2, in which a total of two clusters, with one cluster from each of two vehicles, are sensed. Then, in the frame of each time point in #n-3 to #n in each example, the clusters at the each time point (current clusters) and the clusters at a past time point(s) before the each time point (past clusters) are superposed and indicated. The time interval between frames is, for example, 50 ms, but the present disclosure is not limited thereto.

For example, in frame #n-3, the two clusters at time point #n-3 are indicated, whereas in frame #n-2, the two clusters at time point #n-3 and the two clusters at time point #n-2 are indicated. For example, in frame #n-2, the two clusters at time point #n-3 are the “past clusters”. The same applies to the other time points. For example, in frame #n, the two current clusters at time point #n and the past clusters at time points #n-1 to #n-3 are indicated.

As illustrated in Example 1 in FIG. 8, the two current clusters corresponding to one

vehicle form one locus in a case where the two current clusters and the past clusters are overlapped. In other words, a locus followed by the past clusters according to the passage of time and a locus followed by the two current cluster according to the passage of time, where the two current cluster and the past clusters are overlapped, overlap (in other words, the deviation between the loci is minimum). This locus corresponds to the locus on which the one vehicle corresponding to the clusters has traveled. For this reason, the correlation with respect to the positions of the clusters in each frame is relatively high. On the other hand, as illustrated in Example 2 in FIG. 8, in a case where the current clusters corresponding to the two vehicles, respectively, and the past clusters are overlapped, loci followed thereby according to the passage of time do not overlap. For this reason, the more the number of cluster superpositions, the lower the correlation with respect to the positions of the clusters. Thus, the case where loci followed by clusters overlap can be said as a case where the inter-cluster correlation of a time-series change (or a change over time) in positions in which the clusters occur is relatively high.

Whether a plurality of clusters is coupled, in other words, whether two clusters correspond to the same sensing target can be determined based on, for example, the overlapping degree of loci in a case where the clusters and past clusters are overlapped.

Cluster coupler 1100 determines, for example, based on predetermined conditions (cluster coupling conditions), whether a plurality of clusters sensed at a given time point is coupled. Hereinafter, as an example, in the cluster coupling processing, first determination whether clusters are coupled is performed based on four conditions for vehicle types classified based on the distance between clusters, the positional relationship with past clusters, the correlation coefficient between clusters, and cluster features.

Note that, the four conditions described above are examples and the present disclosure is not limited thereto. For example, one or some of the four conditions may be omitted, or any other condition other than the four conditions may be added. Further, the distance between clusters may be represented, for example, by a Euclidean distance or a Manhattan distance.

Cluster coupler 1100 creates, for example, a cluster coupling table based on a result of the first determination and performs second determination of clusters to be coupled by using the cluster coupling table.

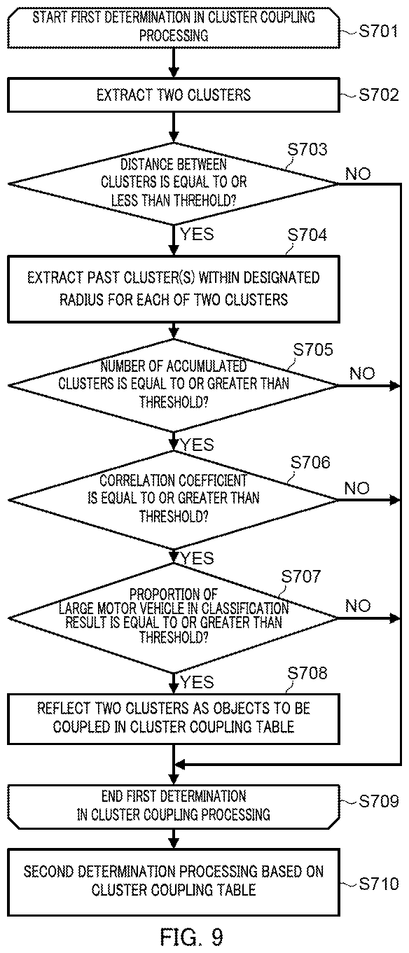

FIG. 9 is a flowchart illustrating an example of the first determination in the cluster coupling processing. The first determination in the cluster coupling processing illustrated in FIG. 9 is started, for example, in a stage in which cluster coupler 1100 acquires a processing result from classifier 800 (S701).

Cluster coupler 1100, for example, extracts (or selects) two clusters among clusters sensed in a frame to be processed (S702). Note that, identification information (for example, an ID) for identifying each cluster in the frame may be given to each cluster.

Cluster coupler 1100, for example, determines whether the distance between the two extracted clusters is equal to or less than a threshold (S703). For example, the threshold of distance is 10 m.

In a case where the distance between the clusters is neither equal to nor less than the threshold (NO in S703), the first determination in the coupling processing on the two extracted clusters ends (S709).

In a case where the distance between the clusters is equal to or less than the threshold (YES in S703), cluster coupler 1100 superposes information on past clusters thereon, thereby extracting, for example, for each of the two clusters, a past cluster(s) present within radius r, which has been designated, from the center of each cluster (S704). The information on past clusters includes past clusters for 50 frames sensed at past time points before a current time point. Further, radius r having been designated is, for example, 7.5 m. Note that, although it has been described that the information on past clusters is for 50 frames, the present disclosure is not limited thereto. The number of frames in the information on past clusters may be changed. For example, the number of frames in the information on past clusters may be changed dynamically based on any other parameter (for example, the velocity of the sensing target), or the user may configure and change the number of frames in the information on past clusters.

Cluster coupler 1100 determines whether the number of accumulated clusters is equal to or greater than a threshold (S705). The accumulated clusters may include, in S704 described above, the past cluster(s) present within radius r, which has been designated, of each of the two clusters and the clusters in the frame at the current time point. The threshold with respect to the number of clusters may be, for example, 25.

In a case where the number of accumulated clusters is neither equal to nor greater than the threshold (NO in S705), the first determination in the coupling processing on the two extracted clusters ends (S709).

In a case where the number of accumulated clusters is equal to or greater than the threshold (YES in S705), cluster coupler 1100 determines, for example, whether the correlation coefficient is equal to or greater than a threshold (S706). Here, the correlation coefficient is a coefficient indicating the correlation of the positional relationship between the accumulated clusters and may be expressed as |r_{xy}|. The correlation coefficient is, for example, a value indicating that the correlation is high in a case where the positions of the accumulated clusters are present along the same locus, and indicating that the correlation is low in a case where there are variations in the positions of the accumulated clusters. For example, in a case where the correlation coefficient indicating that the correlation is the highest is 1 and the correlation coefficient indicating that the correlation is the lowest is 0, the threshold with respect to the correlation coefficient may be 0.95.

In a case where the correlation coefficient is neither equal to nor greater than the threshold (NO in S706), the first determination in the coupling processing on the two extracted clusters ends (S709).

In a case where the correlation coefficient is equal to or greater than the threshold (YES in S706), cluster coupler 1100 determines, for example, in each classification result for the accumulated clusters, whether the proportion of a specific vehicle type (for example, large motor vehicle) is equal to or greater than a threshold (S707). For example, in a case where the proportion is expressed in percentage, the threshold with respect to the proportion is 50%.

In a case where the proportion of the large motor vehicle is neither equal to nor greater than the threshold (NO in S707), the first determination in the coupling processing on the two extracted clusters ends (S709).

In a case where the proportion of the large motor vehicle is equal to or greater than the threshold (YES to S707), cluster coupler 1100, for example, determines that the two clusters extracted in S703 are objects to be coupled, and reflects the determination result in the cluster coupling table (S708). Then, the first determination in the cluster coupling processing on the two extracted clusters ends (S709).

Note that, in a case where a pair of two clusters on which the coupling processing is not performed is present among the clusters sensed in the frame to be processed after S709, the processing after S702 may be performed on the two clusters on which the coupling processing is not performed.

After the first determination in the cluster coupling processing is performed on each pair of two clusters among the clusters sensed in the frame to be processed (after S709), cluster coupler 1100 executes second determination processing, for example, based on the cluster coupling table (S710). In this second determination processing, it may be determined that the vehicle type corresponding to the coupled clusters (coupling cluster) is the large motor vehicle.

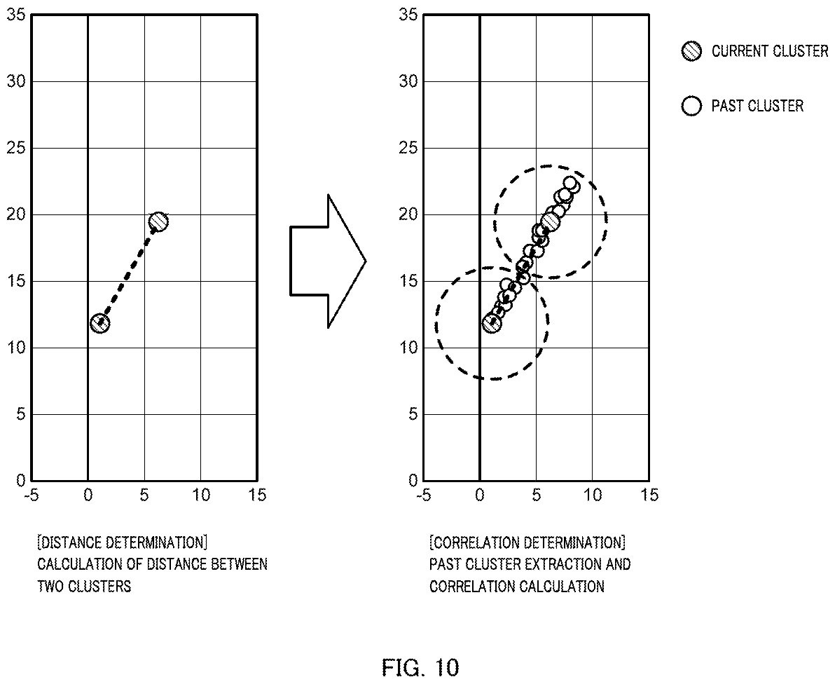

FIG. 10 illustrates an example of processing procedures based on FIG. 9. FIG. 10 exemplifies clusters in a case where a vehicle is viewed from above. In the left of FIG. 10, two clusters (current clusters) included in a frame at a given time point are illustrated.

The distance between the current clusters illustrated in the left of FIG. 10 is equal to or less than the threshold (YES in S703 in FIG. 9). In this case, for each of the two clusters, a past cluster(s) present within radius r from the center of each cluster is/are extracted (S704 in FIG. 9).

In the right of FIG. 10, clusters (past clusters) in a frame at a past time point before the time point of the frame illustrated in the left of FIG. 10 are superposed on the current clusters and indicated. In the right of FIG. 10, clusters included in each circle with radius r are extracted.

In the example in the right of FIG. 10, the number of extracted clusters is equal to or greater than the threshold (YES in S705), the correlation coefficient is equal to or greater than the threshold (YES in S706), and the proportion of the large motor vehicle is equal to or greater than the threshold (YES in S707). In this case, it is determined that the two clusters illustrated in the left of FIG. 10 are objects to be coupled. In a case where the two clusters are the objects to be coupled, the two clusters as the objects to be coupled are reflected in the cluster coupling table.

Next, an example of the second determination processing in the cluster coupling processing based on the cluster coupling table will be described. Note that, the cluster coupling table indicates pairs of clusters, which are determined as satisfying the cluster coupling conditions in the first determination exemplified in FIG. 9, and pairs of clusters, which are determined as not satisfying the cluster coupling conditions in the first determination exemplified in FIG. 9, in a tabular form. In other words, the cluster coupling table visually indicates whether the correspondence relationship between two clusters has a relationship that satisfies the cluster coupling conditions or has a relationship that does not satisfy the cluster coupling conditions. Note that, the correspondence relationship between two clusters may not be processed in a tabular form.

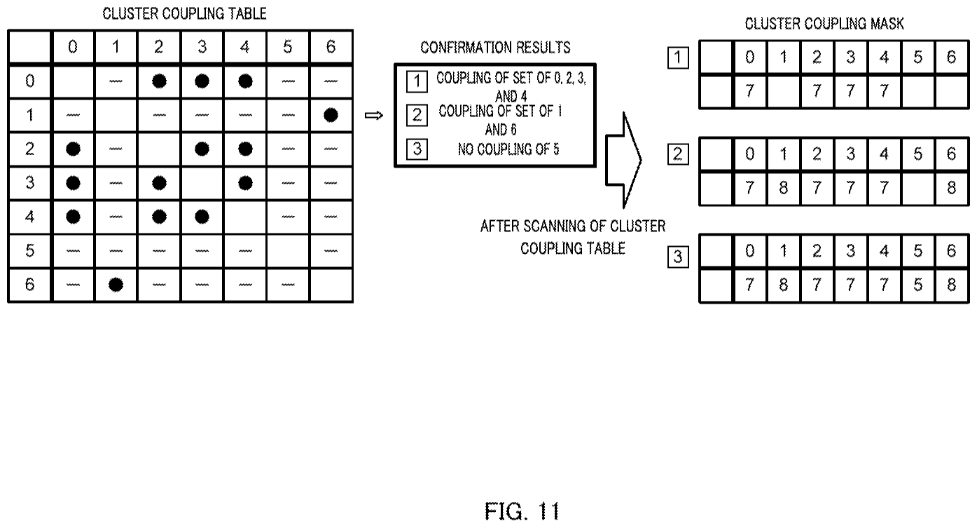

FIG. 11 illustrates a first example of the coupling processing based on the cluster coupling table. In the left of FIG. 11, a cluster coupling table generated for clusters to which six IDs of “1” to “6” are given is illustrated. Note that, in the following description, a cluster to which an ID: i is given will be described as cluster #i. In the example of FIG. 9, i is an integer equal to or greater than 0 and equal to or less than 6. In the center of FIG. 11, an example of confirmation procedures for objects to be coupled with respect to the cluster coupling table is illustrated. In the right of FIG. 11, an example of cluster coupling mask including second determination results as to whether clusters are coupled is illustrated.

In the rows and columns of the numerical value “i” in the cluster coupling table in FIG. 11, “●” indicates a cluster(s) determined as being coupled to cluster #i in the first determination, and “−” indicates clusters determined as not being coupled to cluster #i in the first determination.

The row and column of “0” in the cluster coupling table in FIG. 11 indicate that it is determined in the first determination that cluster #0 is coupled to clusters #2, #3, and #4.

In a case where it is determined that cluster #0 is coupled to clusters #2, #3, and #4, it is confirmed in the cluster coupling table whether clusters #2, #3, and #4 are coupled to each other.

As illustrated in the row and column of “2” in the cluster coupling table in FIG. 11, it is determined in the first determination that cluster #2 is coupled to clusters #3 and #4. Further, as illustrated in the row and column of “3” in the cluster coupling table in FIG. 11, it is determined that cluster #3 is coupled to cluster #4.

In this case, it is determined in the second determination that clusters #0, #2, #3, and #4 are coupled as indicated in “1” in the confirmation results. Since it is determined that clusters #0, #2, #3, and #4 are coupled, a new ID: 7 is given to clusters #0, # 2, # 3, and #4 as indicated in “1” in the cluster coupling mask in FIG. 11.

The row and column of “1” in the cluster coupling table in FIG. 11 indicate that it is determined in the first determination that cluster #1 is coupled to cluster #6 (see “2” in the confirmation results). In this case, no other clusters than clusters #1 and #6 are included, and thus, there may be no procedure for next confirmation in the cluster coupling table.

Further, in this case, a new ID: 8 is given to clusters #1 and #6 as illustrated in “2” in the cluster coupling mask in FIG. 11.

The row and column of “5” in the cluster coupling table in FIG. 11 indicate that it is determined in the first determination that there is no cluster to be coupled to cluster #5 (see “3” in the confirmation results). In this case, the ID: 5 is not changed as illustrated in “3” in the cluster coupling mask in FIG. 11.

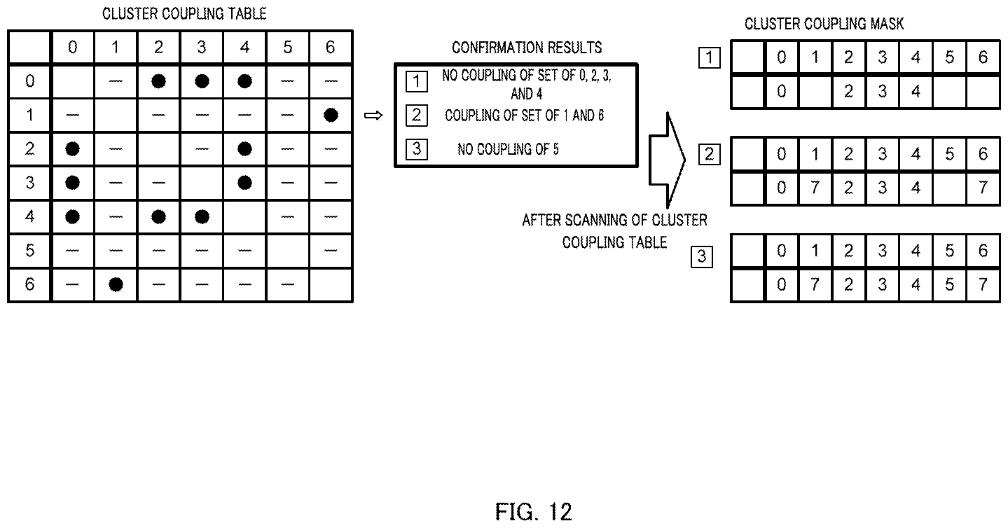

FIG. 12 illustrates a second example of the coupling processing based on a cluster coupling table. In the same manner as in FIG. 11, FIG. 12 illustrates a cluster coupling table, coupling confirmation procedures, and a cluster coupling mask. The difference between FIGS. 11 and 12 lies in that FIG. 11 is an example in which it is determined that clusters #2 and #3 are coupled, whereas FIG. 12 is an example in which it is determined that clusters #2 and # 3 are not coupled.

In the same manner as in FIG. 11, the row and column of “0” in the cluster coupling table in FIG. 12 indicate that it is determined in the first determination that cluster #0 is coupled to clusters #2, #3, and #4.

In a case where it is determined that cluster #0 is coupled to clusters #2, #3, and #4, it is confirmed in the cluster coupling table whether clusters #2, #3, and #4 are coupled to each other.

As illustrated in the row and column of “2” in the cluster coupling table in FIG. 12, it is determined in the first determination that cluster #2 is coupled to cluster #4 and is not coupled to cluster #3. In a case where it has been determined in the first determination that one or more of pairs in clusters #0, #2, #3, and #4 are not coupled, it is determined in the second determination that clusters #0, #2, #3, and #4 are not coupled as indicated in “1” in the confirmation results. In this case, no new ID is given to clusters #0, # 2, # 3, and # 4 as indicated in “1” in the cluster coupling mask in FIG. 12.

In the same manner as in FIG. 11, the row and column of “1” in the cluster coupling table in FIG. 12 indicate that it is determined in the first determination that there is no cluster to be coupled to cluster #5 (see “2” in the confirmation results). For this reason, a new ID: 7 will be given to clusters #1 and #6 (see “2” in the cluster coupling mask).

Note that, IDs to be given to coupled clusters in the secondary determination are not particularly limited. For example, an ID of coupled clusters may be identified as an ID of non-coupled clusters. As an example, such allocation may be performed in which the number of digits for an ID of coupled clusters differs from the number of digits for an ID of non-coupled clusters.

Further, a feature value may be newly configured for a coupling cluster. For example, the position (X, Y, Z coordinates) of a coupling cluster may be newly configured. For example, the Y coordinate of a coupling cluster may be the minimum Y coordinate among those of the plurality of clusters prior to being coupled. In this case, the X coordinate of the coupling cluster may be the X coordinate of the cluster corresponding to the Y coordinate. Further, the Z coordinate of a coupling cluster may be the average of the Z coordinates of the plurality of clusters prior to being coupled. Further, the feature value of a coupling cluster may be the average of feature values of the plurality of clusters prior to being coupled.

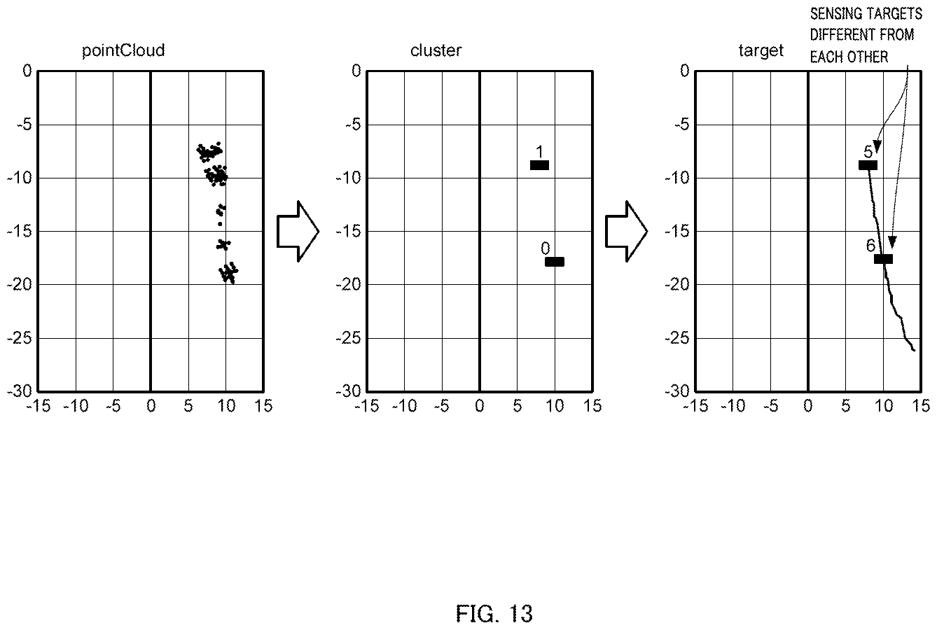

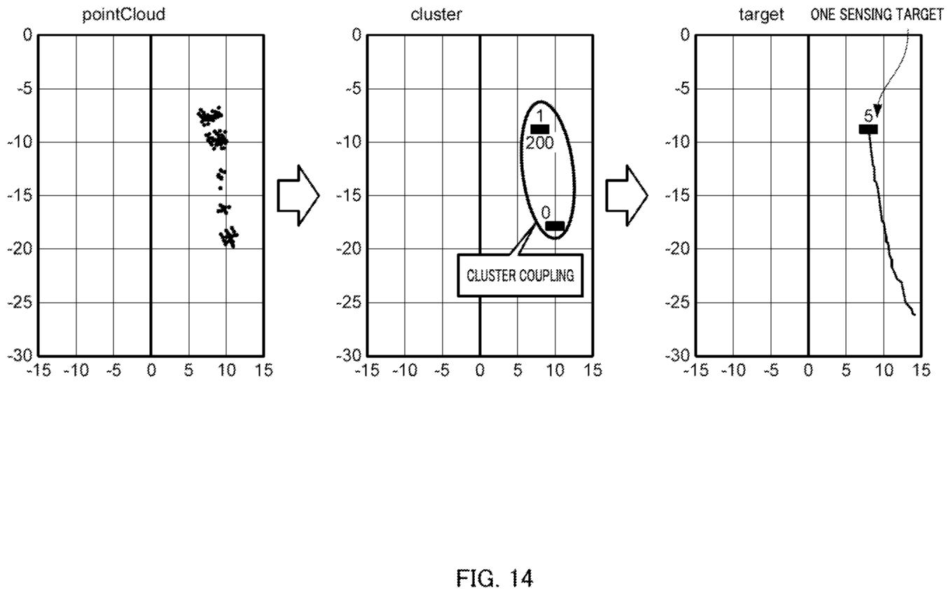

FIG. 13 illustrates a determination example in a case where the cluster coupling processing is not performed. FIG. 14 illustrates a determination example in a case where the cluster coupling processing is performed. FIGS. 13 and 14 indicate the positions of point clouds, two clusters obtained from the point clouds, and a determination result of a sensing target(s) in a case where a vehicle is viewed from above. Note that, the point clouds are the same and the two clusters obtained from the point clouds are also the same between FIGS. 13 and 14.

In the case of FIG. 13, the coupling processing for the two clusters is not performed, and it is therefore determined that the two sensing targets correspond to sensing targets different from each other. In the case of FIG. 14, on the other hand, the coupling processing for the two clusters is performed and it is determined that the two clusters are coupled, and it is therefore determined that one coupling cluster including the two clusters corresponds to one sensing target.

As FIGS. 13 and 14 are compared, it is possible to reduce the determination error rate for a sensing target by executing the cluster coupling processing.

### Time-Series Information Processing

Next, the time-series information processing will be described. In the time-series information processing, the vehicle type of a sensing target is classified in view of vehicle type classification results at a plurality of time points (in a plurality of frames).

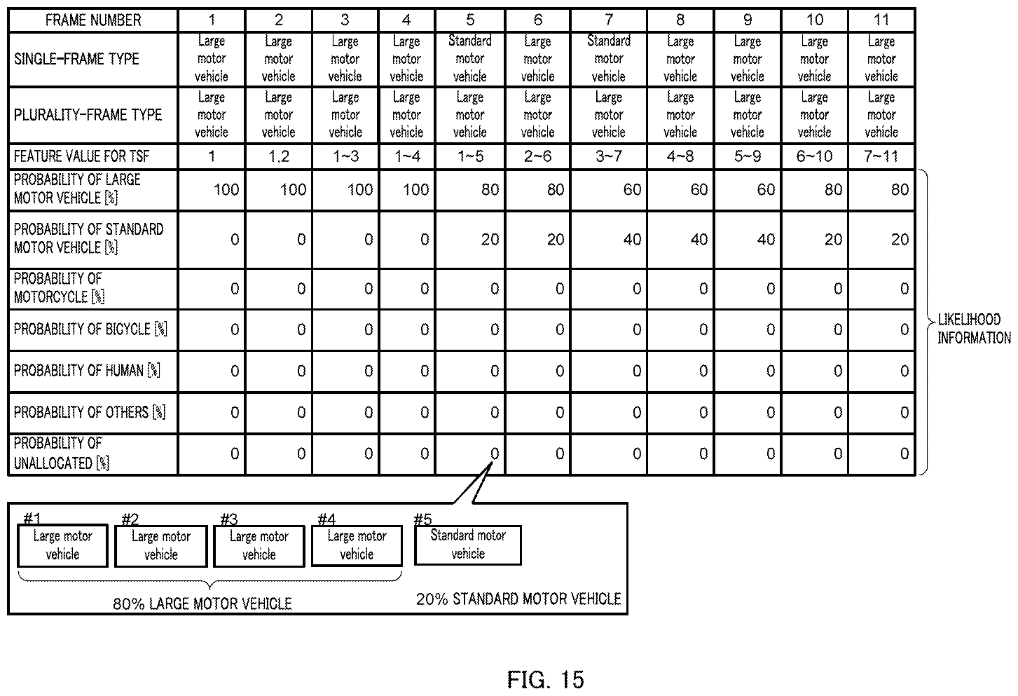

FIG. 15 illustrates a first example of vehicle type classification based on type information and likelihood information of a plurality of frames. Hereinafter, vehicle type classification for one sensing target will be described as an example.

FIG. 15 indicates, in each of frames (frames #1 to #11) to which frame numbers of “1” to “11” are given, a type classified using a sole frame (single frame) (hereinafter, this type will be referred to as “single-frame type”) and a type classified using a plurality of frames (hereinafter, this type will be referred to as “plurality-frame type”). Note that, the single-frame types indicated in FIG. 15 correspond to vehicle type classification results of clusters determined as the same sensing target in time series by tracking. Note that, in the example of FIG. 15, frame #1 is the first frame including the sensing target. Further, in each frame, likelihood information, and the numbers of frames used in a case where a time-spatial feature (TSF) is calculated in each frame are indicated.

The likelihood information is information indicating proportions classified within a designated number of frames for each type from classification results of “human, bicycle, motorcycle, standard motor vehicle, large motor vehicle, and others”. In other words, the likelihood information indicates a certainty with which clusters of a sensing target can be determined as “human, bicycle, motorcycle, standard motor vehicle, large motor vehicle, and others”, respectively. Note that, the “others” indicate that a cluster in a frame has not fallen under any of “human, bicycle, motorcycle, standard motor vehicle, and large motor vehicle”. The “unallocated” indicates that no cluster is included in a frame. For example, the case where no cluster is included in a frame corresponds to one of a case where radar apparatus 100 has not sensed any cluster (has not received a reflection wave), a case where no point cloud information has been obtained, and a case where point cloud information has been obtained, but the point cloud information does not include information sufficient for cluster generation (for example, a sufficient number of point clouds).

In the example in FIG. 15, the designated number of frames is five. For example, in the case of frame #5 in FIG. 15, the single-frame type in four frames of frames #1 to #4 among the five frames of frames #1 through #5 is “large motor vehicle”, and the single-frame type in frame #5 is “standard motor vehicle”. In this case, the likelihood information of “large motor vehicle” in frame #5 is 80% and the likelihood information of “standard motor vehicle” is 20%. For example, in the case of frame #7, the single-frame type in frames #3, #4, and #6 among the five frames of frames #3 through #7 is “large motor vehicle”, and the single-frame type in frames #5 and #7 is “standard motor vehicle”. In this case, the likelihood information of “large motor vehicle” in frame #7 is 60% and the likelihood information of “standard motor vehicle” is 40%.

For example, in the example of FIG. 15, it is determined that a vehicle type corresponding to a proportion equal to or greater than a threshold among the proportions in each classification result indicated by the likelihood information is the plurality-frame type (the vehicle type to be sensed). For example, the threshold may be 50%. Since the vehicle type corresponding to the proportion equal to or greater than the threshold among the proportions in each classification result indicated by the likelihood information is “large motor vehicle” in frames #5 and #7, the plurality-frame type (the vehicle type to be sensed) in frames #5 and #7 is “large motor vehicle”.

As exemplified in FIG. 15, performing processing in time series between past frames and a current frame makes it possible to perform correction in a case where a single-frame type deviates from those of the past frames, and makes it possible to reduce determination errors.

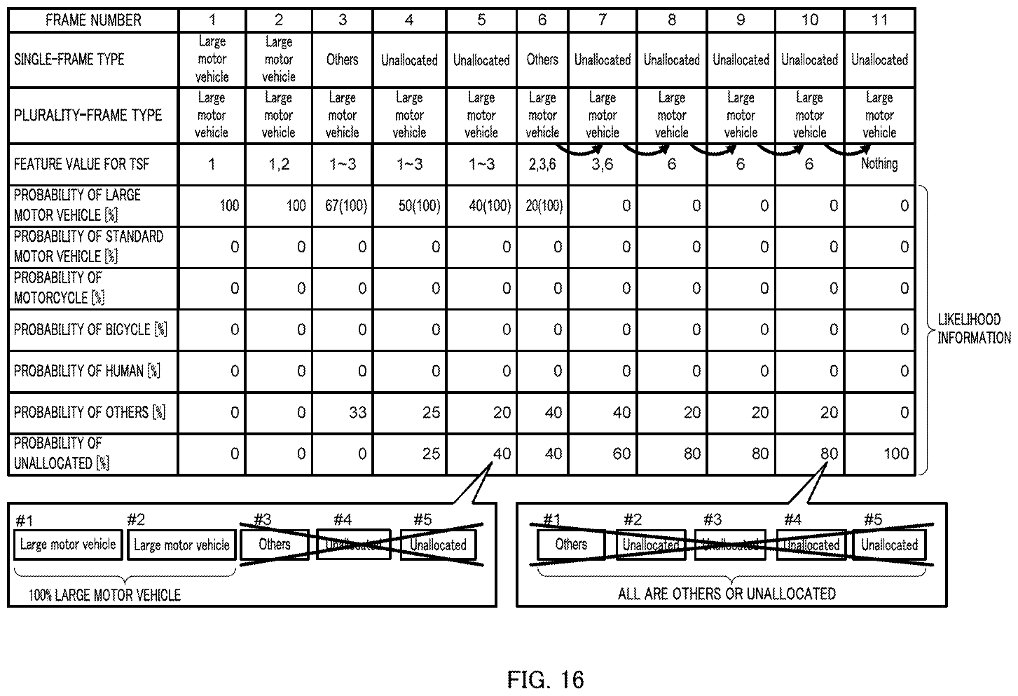

FIG. 16 illustrates a second example of type information and likelihood information of frames at a plurality of time points. In the same manner as in FIG. 15, FIG. 16 indicates, in each of frames #1 to #11, a single-frame type and a plurality-frame type. Note that, in the example of FIG. 16, frame #1 is the first frame including the sensing target. Further, in each frame, likelihood information, and the numbers of frames used in a case where the TSF is calculated in each frame are indicated.

In the example of FIG. 16, the single-frame type in frames #3 and #6 is “others”, and the single-frame type in frames #4, #5, and #7 to #11 is “unallocated”.

For example, in a case where “unallocated” and/or “others” is/are included in single-frame types, the type of the sensing target may be determined based on type likelihood information from which “unallocated” and/or “others” is/are excluded. For example, in FIG. 16, each likelihood information indicated in parentheses corresponds to the type likelihood information from which “unallocated” and/or “others” is/are excluded.

For example, in the case of frame #5, the type of frame #5 is determined based on frames #1 and #2 among the five frames of frames #1 through #5 from which frame #3, which is “others”, and frames #4 and #5, which are “unallocated”, are excluded. For example, since the single-frame type in frames #1 and #2 is “large motor vehicle”, the likelihood information of “large motor vehicle” in frame #5 is 100%. In this case, since the vehicle type corresponding to the proportion equal to or greater than the threshold among the proportions in each classification result indicated by the likelihood information is “large motor vehicle”, the plurality-frame type (the vehicle type to be sensed) in frame #5 is “large motor vehicle”.

Note that, the likelihood information may be included in a determination result and outputted to an external apparatus. In this case, the likelihood information to be outputted may be type likelihood information from which “unallocated” and/or “others” is/are excluded (each likelihood information in parentheses in FIG. 16), may be type likelihood information including “unallocated” and/or “others”, or may be both of those described above.

Further, for example, in a case where each vehicle type classified within the designated number of frames is “others” or “unallocated” in a given frame, the type of a frame prior to the above frame may be reflected. For example, in FIG. 16, the type classified using each sole frame of frames #3 to #7 in frame #7 is “others” or “unallocated”, in which case “large motor vehicle” which is the type classified in frame #6 is reflected in frame #7.

Note that, in a case where a predetermined number of frames in which each vehicle type classified within the designated number of frames is “others” or “unallocated” are continuous, the type classification may be stopped. For example, in the example of FIG. 16, in each of frames #7 to #11, each vehicle type classified within the designated number of frames is “others” or “unallocated”. In a case where such frames are continuous, the type classification may be stopped.

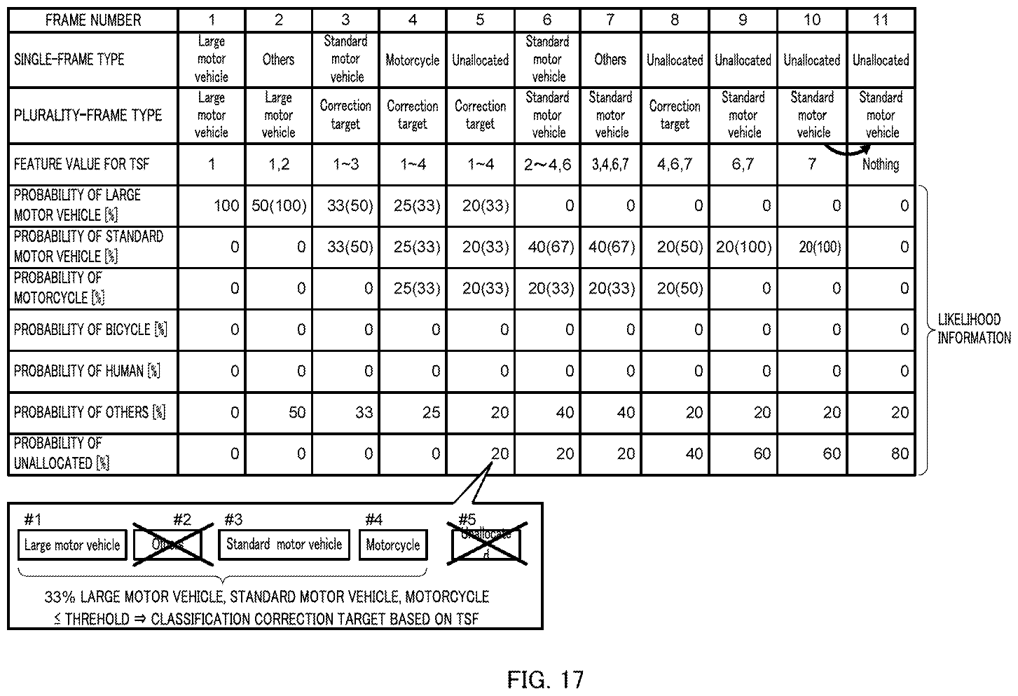

FIG. 17 illustrates a third example of type information and likelihood information of frames at a plurality of times. In the same manner as in FIG. 15, FIG. 17 indicates, in each of frames #1 to #11, a single-frame type and a plurality-frame type. Note that, in the example of FIG. 17, frame #1 is the first frame including the sensing target. Further, in each frame, likelihood information, and the numbers of frames used in a case where the TSF is calculated in each frame are indicated.

In the example of FIG. 17, each type likelihood information from which “unallocated” and/or “others” is/are excluded is indicated in parentheses in the same manner as in FIG. 16. Further, in the example of FIG. 17, the “correction target” indicates that type classification is corrected because no vehicle type corresponding to the proportion equal to or greater than the threshold=50% among the proportions in each classification result indicated by the likelihood information is present. For example, in frame #5, the likelihood information of large motor vehicle is 33%, the likelihood information of standard motor vehicle is 33%, and the likelihood information of motorcycle is 33%. In this case, no vehicle type corresponding to the proportion equal to or greater than the threshold=50% among the proportions in each classification result indicated by the likelihood information is present, which falls under the “correction target”. As described above, in a case where a vehicle type is not determined by comparing the likelihood information with the threshold, the vehicle type may be determined based on the TSF. Hereinafter, exemplary TSFs will be described.

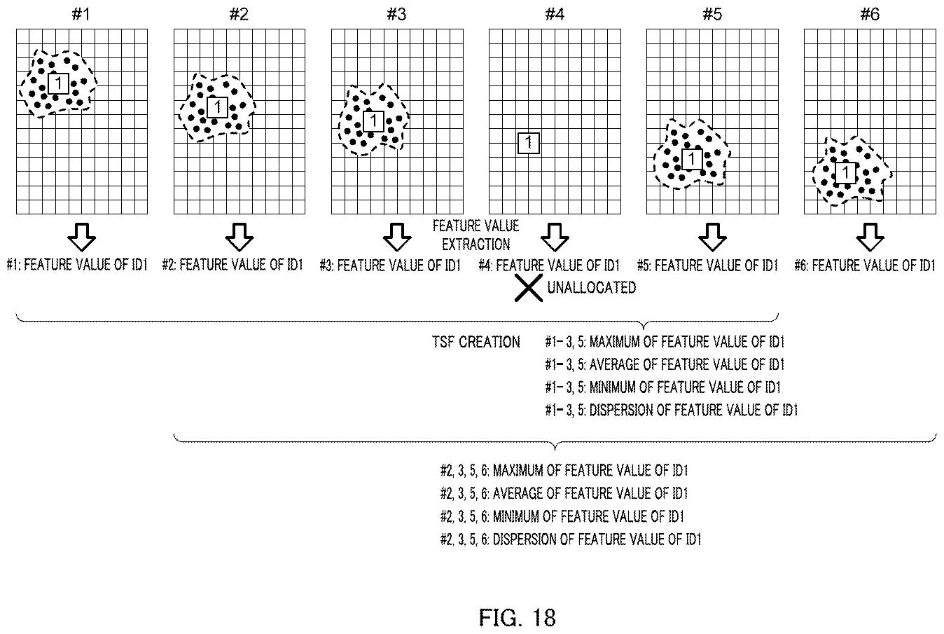

FIG. 18 illustrates exemplary TSFs. As an example, FIG. 18 illustrates exemplary feature values and TSFs for frames #1 to #6.

Frames #1 to #3, #5, and #6 in FIG. 18 include clusters. The same ID=1 is given to these clusters. Note that, frame #4 includes no cluster (that is, unallocated).

Here, a TSF based on frames #1 to #3, and #5 is generated, for example, based on feature values obtained from clusters to which the ID=1 is given in frames #1 to #3, and #5, respectively. For example, the TSF based on frames #1 to #3, and #5 may be one or more of the maximum, average, minimum, and dispersion of the feature values obtained from the clusters to which the ID=1 is given in frames #1 to #3, and #5, respectively. In a case where a plurality of numbers of feature values obtained from clusters is present, the number of TSFs may also be the same as the number of the feature values obtained from the clusters or may be a different number.

Further, a TSF based on frames #2, #3, #5, and #6 is generated, for example, based on feature values obtained from clusters to which the ID=1 is given in frames #2, #3, #5, and #6, respectively. For example, the TSF based on frames #2, #3, #5, and #6 may be one or more of the maximum, average, minimum, and dispersion of the feature values obtained from the clusters to which the ID=1 is given in frames #2, #3, #5, and #6, respectively.

For example, in a case where N kinds of feature values obtained from one cluster are present, each maximum, average, minimum, and dispersion of the N kinds are created for the TSF, and thus, feature values whose number is four times that of a feature value obtained from one cluster are obtained.

Performing the type classification by using the TSF calculated in the above-described manner makes it possible to determine a vehicle type based on the TSF even in a case where the vehicle type is not determined by comparing the likelihood information with the threshold.

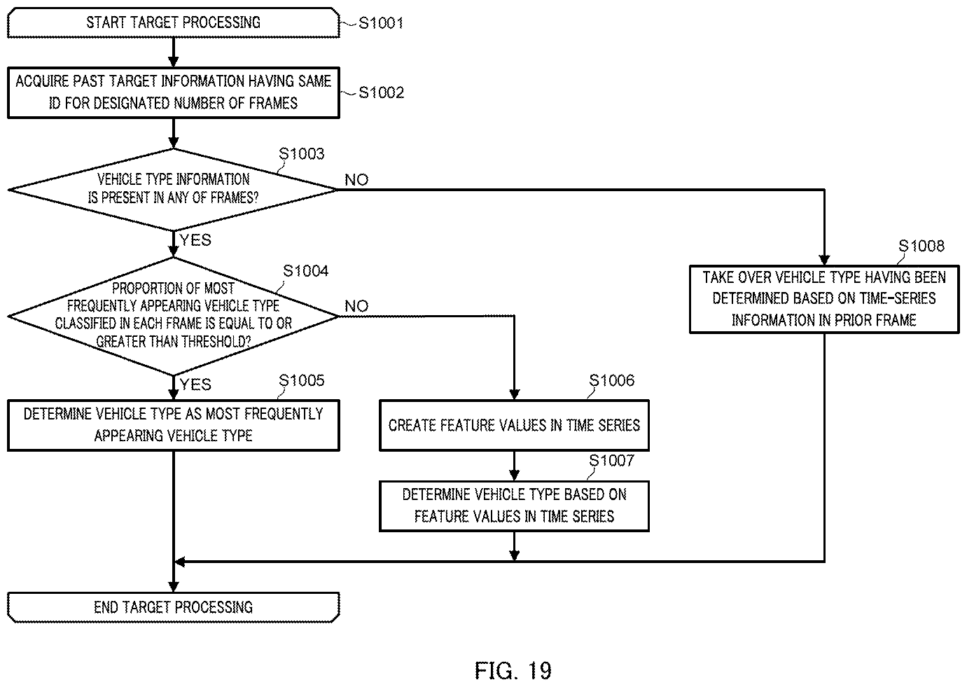

Next, processing procedures in time-series information processing will be described. FIG. 19 is a flowchart illustrating an example of the time-series information processing. The time-series information processing is started, for example, in a stage in which time-series information processor 1500 obtains a processing result from tracker 1200 via time-series information accumulator 1300 (S1001).

Time-series information processor 1500 acquires, from time-series information storage 1400, information on a past cluster(s) having an ID, which is the same in time series as that of a cluster to be determined in a current frame (hereinafter, the information will be referred to as past target information), for a predetermined number of frames (S1002). For example, in the examples of FIGS. 15 to 17, the designated number of frames is five.

Time-series information processor 1500 determines whether vehicle type information is present in any of the acquired frames (S1003). The vehicle type information is, for example, results of vehicle type classification executed on past clusters in the past target information for the number of acquired frames. For example, a case where no vehicle type information is present may be the case of “others” or “unallocated” exemplified in FIGS. 15 to 17.

In a case where vehicle type information is present (YES in S1003), time-series information processor 1500 determines whether the proportion of a most frequently appearing vehicle type is equal to or greater than the threshold (S1004). For example, in the example of frame #5 in FIG. 15, the most frequently appearing vehicle type among the single-frame types in frames #1 through #5 is “large motor vehicle”, and the proportion thereof is 80%.

In a case where the proportion of the most frequently appearing vehicle type is equal to or greater than the threshold (YES in S1004), time-series information processor 1500 determines that a vehicle type corresponding to clusters indicated by the same ID in time series is the vehicle type having the largest proportion (S1005). Then, the flow ends.

In a case where the proportion of the most frequently appearing vehicle type is neither equal to nor greater than the threshold (NO in S1004), time-series information processor 1500 creates feature values in time series (TSF) (S1006). For example, in the case of frame #5 in FIG. 17, the TSF is calculated since no proportion of a vehicle type equal to or greater than the threshold (50%) is present.

Time-series information processor 1500 determines a vehicle type based on the feature values in time series (S1007). For example, time-series information processor 1500 may perform machine learning processing based on the feature values in time series, create a machine learning model, and determine a vehicle type by using the machine learning model. Note that, the machine learning model here may be different from the machine learning model at classifier 800. For example, the machine learning model at time-series information processor 1500 may be created by using the machine learning model at classifier 800. Then, the flow ends.

In a case where no vehicle type information is present (NO in S1003), time-series information processor 1500 determines a vehicle type having been determined based on time-series information in a frame prior to a current frame (S1008). In other words, in this case, a determination result for the prior frame is taken over. Then, the flow ends.

As described above, feature values in time series have more kinds than feature values of clusters in sole frames. For this reason, the use of feature values in time series in S1007 in FIG. 19 makes it possible to improve the vehicle type determination accuracy.

As described above, vehicle sensing system 1 in the present embodiment at least includes one information processing apparatus. The information processing apparatus at least includes: cluster coupler 1100 (an example of the coupler) that performs, based on a time-series change in sensing information (for example, a cluster(s)) produced by radar apparatus 100, coupling of a plurality of pieces of the sensing information, which is sensed at a given clock time, as the sensing information on a sensing target which is a specific sensing target; classifier 800 (an example of the discriminator) that discriminates an attribute of the sensing target based on the sensing information on the sensing target, where the sensing information on the sensing target has been obtained by the coupling; and a vehicle recognition information outputter (an example of the outputter) that outputs a discrimination result of the attribute. This configuration makes it possible to improve the determination accuracy of information on a target to be sensed by radar apparatus 100.

For example, since cluster coupler 1100 couples a plurality of clusters corresponding to the same sensing target into one cluster, it is possible to avoid erroneous determination that a plurality of clusters corresponding to the same sensing target corresponds to a plurality of sensing targets, respectively.

Further, even in a case where variations in feature values of clusters indicated by sensing results of a plurality of frames occur, time-series information processor 1500 is capable of improving the type determination accuracy of a sensing target by referring to information at a past time point(s).

Further, it is possible to determine the number of sensing targets and the type of each sensing target more accurately by executing the cluster coupling processing by cluster coupler 1100 and the time-series information processing by time-series information processor 1500.

Note that, some of the processing indicated in the embodiment described above may be omitted (skipped). For example, the Doppler velocity correction processing may be omitted. Further, one of the cluster coupling processing and the time-series information processing may be omitted.

For example, in a case where the vehicle type classification is not performed, the time-series information processing may be omitted. Further, for example, in a case where no large motor vehicle is sensed (for example, in the case of application to a road where the traveling of large motor vehicles is restricted), the cluster coupling processing may be omitted.

Note that, although an example in which the sensing target(s) is/are a vehicle(s) and the type(s) of the vehicle(s) is/are determined has been indicated in the present embodiment, the sensing target(s) of the present disclosure is/are not limited to a vehicle(s).

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

In recent years, in Internet of Things (IoT) technology, Cyber Physical Systems (CPSs), which are a new concept of creating new added value by information cooperation between a physical space and cyberspace, has attracted attention. This CPS concept can also be adopted in the above embodiment.

That is, a basic configuration of the CPSs is, for example, such that an edge server disposed in the physical space and a cloud server disposed in the cyberspace can be connected to each other via a network, and processes can be distributedly processed by processors mounted in these servers. Here, it is preferable that pieces of processed data generated in the edge server or the cloud server be generated on a standardized platform. By using such a standardized platform, it is possible to efficiently build a system including various sensor groups and IoT application software.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Although the embodiments have been described above with reference to the accompanying drawings, the present disclosure is not limited to such examples. It is obvious that a person skilled in the art can arrive at various variations and modifications within the scope described in the claims. It is understood that such variations and modifications also belong to the technical scope of the present disclosure as a matter of fact. Further, components in the embodiments described above may be arbitrarily combined without departing from the spirit of the present disclosure.

Further, the specific examples in the present disclosure are merely exemplary and do not limit the scope of the claims. The techniques described in the scope of the claims include various variations and modifications of the specific examples exemplified above.

The disclosure of Japanese Patent Application No. 2021-112163, filed on Jul. 6, 2021, including the specification, drawings and abstract, is incorporated herein by reference in its entirety.

### INDUSTRIAL APPLICABILITY

An exemplary embodiment of the present disclosure is suitable for a radar system.

### REFERENCE SIGNS LIST

100 Radar apparatus
200 Radar controller
300 Configurator
400 Doppler velocity corrector
500 Preprocessor
600 Clustering processor
700 Feature value creator
800 Classifier
900 Learning information database (DB)
1000 Discrimination information learner
1100 Cluster coupler
1200 Tracker
1300 Time-series information accumulator
1400 Time-series information storage
1500 Time-series information processor
1600 Vehicle recognition information outputter

1. An information processing apparatus, comprising:
a coupler that performs coupling of, based on a time-series change in sensing information produced by a radar apparatus, a plurality of pieces of the sensing information as the sensing information on a sensing target, the plurality of pieces of sensing information being sensed at a given clock time, the sensing target being a specific sensing target;
a discriminator that discriminates an attribute of the sensing target based on the sensing information on the sensing target, the sensing information on the sensing target having been obtained by the coupling; and
an outputter that outputs a discrimination result of the attribute.

2. The information processing apparatus according to claim 1, wherein
the discriminator discriminates the attribute of the sensing target based on likelihood information for each attribute candidate at a plurality of clock times, the likelihood information resulting from classifying the attribute of the sensing target based on the sensing information on the sensing target, the sensing information on the sensing target having been obtained by the coupling.

3. The information processing apparatus according to claim 1, wherein
in a case where the coupler determines that a locus indicated by a change in first sensing information and a locus indicated by a change in second sensing information overlap in a frame including the first sensing information and the second sensing information, the coupler couples the first sensing information and the second sensing information, the frame being obtained by overlapping a frame corresponding to a first clock time and including the first sensing information and a frame corresponding to a second clock time and including the second sensing information.

4. The information processing apparatus according to claim 2, wherein
the coupler determines, based on a distance between the first sensing information and the second sensing information and past sensing information, whether the loci overlap, the past sensing information being at a predetermined distance from each of the first sensing information and the second sensing information.

5. The information processing apparatus according to claim 2, wherein
the discriminator determines a first attribute as the attribute of the sensing target, the first attribute being an attribute in which the likelihood information has exceeded a threshold continuously over a plurality of times at the plurality of clock times.

6. The information processing apparatus according to claim 5, wherein
in a case where the attribute of the sensing target is not discriminated after, among the plurality of clock times, a clock time at which the first attribute is determined, the discriminator does not change the first attribute having been determined.

7. The information processing apparatus according to claim 5, wherein
in a case where a piece of the likelihood information does not exceed the threshold, the discriminator discriminates the attribute of the sensing target based on a time-spatial feature (TSF) obtained from feature values of the sensing information at the plurality of clock times, the piece of the likelihood information being highest in the likelihood information for each attribute candidate.

8. An information processing method, comprising:
performing, by an information processing apparatus, coupling of, based on a time-series change in sensing information produced by a radar apparatus, a plurality of pieces of the sensing information as the sensing information on a sensing target, the plurality of pieces of sensing information being sensed at a given clock time, the sensing target being a specific sensing target;
discriminating, by the information processing apparatus, an attribute of the sensing target based on the sensing information on the sensing target, the sensing information on the sensing target having been obtained by the coupling; and
outputting, by the information processing apparatus, a discrimination result of the attribute.

9. A program that causes an information processing apparatus to execute:
performing coupling of, based on a time-series change in sensing information produced by a radar apparatus, a plurality of pieces of the sensing information as the sensing information on a sensing target, the plurality of pieces of sensing information being sensed at a given clock time, the sensing target being a specific sensing target;
discriminating an attribute of the sensing target based on the sensing information on the sensing target, the sensing information on the sensing target having been obtained by the coupling; and
outputting a discrimination result of the attribute.
